(19) United States
(12) Patent Application Publication
(10) Pub. No.: US 2010/0139800 A1
(43) Pub. Date: Jun. 10, 2010

(54) TUBULAR BODY COMPRISING TWO OR MORE LAYERS OF HELICALLY BENDED STRIPS

(76) Inventors: Raymond Nicholas Burke, Aberdeen (GB); Ruben Van Schalkwijk, Huizen (NL); Richard James Anthony Smith, Rijswijk (NL); Nicholas John Venero, New York, NY (US)

Correspondence Address: SHELL OIL COMPANY, P O BOX 2463, HOUSTON, TX, 772522463, US

(21) Appl. No.: 12/596,096

(22) PCT Filed: Apr. 16, 2008
(86) PCT No.: PCT/EP08/54582

§ 371 Date: Feb. 18, 2010

(30) Foreign Application Priority Data
Apr. 16, 2007 (EP) 07106221.0

(51) Int. Cl. F16L 9/14

(52) U.S. Cl. 138/134; 138/144; 138/138; 138/143

(57) ABSTRACT

The invention concerns an elongated, multilayered tubular body (1) comprising an elongated, tubular inner hollow core (5), an elongated, tubular inner casing (4) and an elongated, tubular outer casing, the inner casing surrounding the hollow core, the outer casing surrounding the inner casing, the outer casing comprising at least two layers (2,3), each layer consisting of one or more longitudinally preformed, flat elongated metal strips, the preforming of the strips such that the strips have been bent helically in such, a way that the consecutive windings of the helix touch or almost touch to each other, each strip in one layer overlapping with other strips in other layers, the layers in the outer casing being bound to each other by an adhesive. The invention further concerns the use of the elongated tubular bodies in the transport of hydrocarbons as oil and/or natural gas optionally containing hydrogen sulphide and/or carbon dioxide or for the transport of gasses and/or liquids as carbon dioxide, hydrogen, water or steam.

The invention relates to novel tubular bodies. More particularly the invention concerns an elongated, multilayered tubular body comprising an elongated, tubular inner hollow core, optionally an elongated, tubular inner casing and an elongated, tubular outer casing, the inner casing surrounding the hollow core, the outer casing surrounding the inner casing, the outer casing comprising at least two layers of longitudinally preformed, flat metal strip. The preforming of the metal strips comprises especially bending the strips in such a way that each strip is converted into a helix by plastical deformation. The preformed metal strip can be made, for example, of a high strength steel, especially steels with a high proportion of its material in the martensitic phase. Preferably an elongated tubular inner casing is present. The inner casing can be made, for example, of a corrosion resistant material. Such tubular bodies have the advantage that high internal pressures can be withstood by the outer casing through the use of high strength helical strips. The use of high strength helical strips results in a relatively small wall thickness, hence for a relatively low weight tubular body.

In general, it is advantageous to try to minimize the weight of pipelines (per meter), while at the same time maintaining the specifications of the maximum allowable pressure at which the pipeline can be operated. Or, expressed in a different way, it is advantageous to increase the maximum allowable pressure at which the pipeline can be operated, while the weight (per meter) remains the same.

It is known that natural gas and liquid petroleum products may contain undesired contaminants, especially undesired acidic contaminants as carbon dioxide and hydrogen sulphide. Further, organic acids as well as chlorides may be present. It is also known that under standard operating conditions of pressure and temperature, pipelines formed of conventional materials carrying such contaminated products may be subject to failure, for instance due to stress corrosion cracking. Such failures may result in longitudinally extending fractures of the pipelines.

Previous attempts to reduce the risk of such failures have involved the use of corrosion inhibitors, added to the products being carried by the pipelines. Unfortunately, this may result in unacceptable costs including not only the cost of the inhibitors and adding them to the products but also the cost of removing and recovering the corrosion inhibitors in due course from the products carried by the pipelines. The use of corrosion inhibitors is also not advisable, particularly in offshore pipelines, due to potential environmental problems created if there is an escape of the corrosion inhibitors from the pipelines.

Alternative ways of reducing the risk of cracking, especially stress corrosion cracking, in pipes by reducing the tensile stress on the part of the pipes in contact with the contaminated products being carried have been proposed. These include the use of pipes formed of, for example, two tubes inserted one inside the other and to then during production mechanically forcing the inner pipe into contact with the outer pipe so that the inner pipe after completion of this operation has a compressive stress and the outer pipe has a tensile stress. This process is known as “auto-frettage” and one way of carrying out this operation mechanically is described in U.S. Pat. No. 4,823,847. It will be appreciated that the two pipes must be made to very tight tolerances if one is to be able to insert one into the other and perform an auto-frettage step without adversely damaging the inner pipe. It will also be appreciated that this particular auto-frettage operation is only suitable for use in small lengths of pipe and suffers from the disadvantage of being a time consuming and therefore expensive operation to carry out. A further disadvantage of the production of a pipeline from such small lengths of pipe, typically 8 to 10 meter lengths, is that it will involve numerous joints being made which in themselves are points of weakness in a pipeline.

Tubular bodies of a different kind are known from U.S. Pat. No. 4,657,049 in which metal strips are helically wound in overlapping fashion and embedded in an adhesive matrix to produce a rigid tubular structure. U.S. Pat. No. 3,530,567 describes a method of forming a tube by helically winding a metal strip in self-overlapping fashion so that the thickness of the wall of the tube at any point is formed from a plurality of laps. In order to remove the helical ridges on the internal bore of the tube formed by the edges of the strip, the laps of the strip material are flattened one against the other after winding by expanding the tubular structure beyond the yield point of the metal strips. Such a procedure presents significant manufacturing difficulties.

In GB 2280889 a method is disclosed to form a hollow elongated or tubular body which comprises helically winding at least one strip of material in self-overlapping fashion to provide a multi-layer tubular structure. In this arrangement the strip is longitudinally pre-formed to provide a transverse cross-section having at least one step which, in each convolution of the strip accommodates the overlapping portion of the next convolution. A tubular body having a wall thickness formed of a plurality of laps may thus be continuously made from a single strip of material, the wall thickness generally being one strip thickness greater than the number of steps formed in the cross-section of the strip. A similar tubular body is described in WO 2006/016190.

The production of preformed self overlapping strips requires specialized, expensive, heavy and energy consuming equipment. Further, the process is quite sensitive, and causes stress concentration (expressed by the stress concentration factor) that may weaken the strength of the pipe. Bending a profiled strip causes an uneven distribution of stress across the strip which may result in early failure. This is especially disadvantageous when long tubular elements are to be made and used.

The object of the present invention is to provide a tubular body and a method of forming the same in which the risk of stress corrosion cracking is reduced and in which one or more of the other above-mentioned disadvantages of the known pipes and methods of forming same are alleviated. The new tubular body comprises two or more relatively simple preformed metal strips around an inner casing, preferably a relatively light inner casing. The preformed metal strip is a simple flat, prebended strip without any profile. The pre-bending results in a helical shape. The preformed metal strips in the finished tubular body are not self overlapping. The inner casing is preferably corrosion resistant. In this way the requirements of the pipeline (corrosion resistance and strength) are, at least partly, separated. The inner casing provides especially the corrosion resistance, the outer layers provide the major part of the strength (axial as well as radial). The hollow core in the centre of the elongated body is the space for the transport of gas and/or liquids. In the case of the use of high-strength steel in the outer casing, the result will be a very strong pipe, while the weight will be less than that of a conventional pipe having the same pressure specification.

Thus, the present invention relates to an elongated, multilayered tubular body comprising an elongated, tubular inner hollow core, optionally an elongated, tubular inner casing and an elongated, tubular outer casing, the inner casing surrounding the hollow core, the outer casing surrounding the inner casing, the outer casing comprising at least two layers, each layer consisting of one or more longitudinally preformed, flat elongated metal strips, the preforming of the strips such that the strips have been bent helically in such a way that the consecutive windings of the helix touch or almost touch to each other, each strip in one layer overlapping with other strips in other layers, the layers in the outer casing being bound to each other by an adhesive. The cross-section of the body, in the absence of external forces, will be circular. In the case that there is not an inner casing, the outer casing is directly surrounding the inner hollow core.

By virtue of the feature that flat metal strip can be used to prepare the preformed helix shaped outer casing layers, hardly any failures will be present in the preformed strip, for instance due to stress concentration. Further, the preformed strip can be made in a simple process step. Especially when using high strength steel alloy, e.g. with a high proportion of its crystal grains in the martensitic phase, tubular bodies are obtained which can withstand high pressures. The use of especially corrosion resistant inner casings will reduce any stress corrosion. By using overlapping layers of preformed strips in the outer casing a substantial portion of the axial load is taken up by the outer casing. The tubular bodies of the present invention may withstand the same internal pressure, while a material weight saving of 40% or more is obtained when compared with standard pipe. Especially the combination of high martensitic phase content steel strips and pre-bending is advantageous as without pre-bending the finished pipe product will contain a large amount of elastical deformation energy, which makes the production process as well as any repairs a difficult procedure.

The pre-bending of the strip involves applying suitable forces to obtain a helix shaped strip by plastical deformation of the metal. This can be done, for instance, by continuously bending and moving the strip over a roller or by winding the strip helically over a (short) cylinder. In the case that a layer is formed by one metal strip, the diameter of the helix (without any forces causing elastic deformation) is of the same order of magnitude as the inner casing, while the consecutive windings of the helix just touch to each other or show a small gap or overlap that can be overcome by elastic deformation of the metal only, to obtain a small gap as defined below. The diameter of the helix may be between 0.6 and 1.4 times the diameter of the inner casing, suitably, the diameter of the helix is between 0.8 and 1.25 times the diameter of the inner casing, preferably between 0.9 and 1.12, more preferably between 0.97 and 1.04. It is observed that the pre-bending of the flat metal strips is a helical pre-bending, resulting in a helix shaped strip. In the case of cylindrically pre-bending a helix may be obtained by pulling apart the ends of strip, however, in that case the edges of the adjacent helix windings will not align with each other. The pre-bending needs to be done in two direction in order to get a helix in which the edges aligned.

It will be understood that the diameter of consecutive layers in the finished tubular body need to be slightly larger than the previous layer. In the case of two (or more) metal strips in the same layer of the tubular body, the distance between consecutive windings in the helix (containing the two (or more) strips) is the width of two (or more) strips, optionally together with two (or more) small gaps or overlaps as defined below. Please note that in the case of two (or more) metal strips in one layer, the next layer may be of the same structure or may comprise less or more strips. In order to obtain the desired overlap of the consecutive layers (in which the gap or the contacting line between two windings of a helix (as well as any gaps or contacting lines in the case of two or more strips in one helix) is covered by a helix of the consecutive layer over the total length of the pipe) it is necessary that the pitch of each helix in a layer, comprising the one or more strips, is the same for all layers. Preferably each layer consists of one or two metal strips, more preferably one metal strip.

The elongate tubular body according to the present invention preferably comprises an elongated tubular inner casing. Such an inner casing may be deleted in the case that the tubular body is used to transport non-corrosive materials, e.g. compressed air, water, steam, nitrogen, pure methane etc.

In principle, the length of the elongated tubular body may vary from one meter to 40 km or even more.

Suitably the length is at least 10 meters, preferably between 100 meters and 20 km, more preferably between 500 m and 5 km. In principle a continuous method can be used to make the tubular method of the invention. Thus, only a restricted number of joints are required for long distance pipe lines. The elongated tubular body of the present invention comprises two or more layers in the outer casing, in each layer the windings of the flat metal strip lay adjacent to each other, without any overlap.

In principle there are no restrictions as to the diameter of the tubular body. Suitably the inner hollow core has a diameter of between 5 and 250 cm, preferably between 10 and 150 cm, more preferably between 15 and 125 cm. The outer casing will comprise at least two layers. When using only one layer, the axial load resistance would be too low. In principle, there is no limit to the maximum number of layers, but a practical number will be up till 24, especially up till 20. Suitably the outer casing comprises between 2 and 16 layers, preferably between 2 and 10 layers, more preferably between 3 and 8 layers, especially 4-6 layers. It will be appreciated that more layers will result in pipes that can withstand higher pressures. Also a higher axial strength is obtained.

The elongated tubular body, when comprising one strip in each layer, suitably has a ratio circumference/strip width between 3 and 40, preferably 4 and 28, more preferably between 6 and 20, the circumference being the circumference of the smallest layer (or the first layer around the hollow core) of the outer casing. In the case of more than one strip in a layer, the strip width is defined as the sum of the strip widths in that layer.

The distance between two windings in one layer in the outer casing is preferably relatively small. In that way the forces can be transferred relatively easy without any potential problems with respect to cracking of adhesive layers. Suitably, the axial gap, if present, between two consecutive helix windings is at most a quarter of the strip width, preferably at most a sixth of the strip width, more preferably at most a tenth of the strip width. Sufficient overlap between the layers is thus obtained to transfer the forces. Suitably the gap between two windings of the strip is at most 1 cm, preferably at most 0.4 cm, more preferably at most 0.1 cm.

Preferably the inner casing and the outer casing are being bound to each other by an adhesive. Preferred adhesives are described herein below.

The distance between the inner casing and the first layer in the outer casing is suitably at most 2 mm, preferably between 0.01 and 1 mm. In a similar way, the distance between two layers in the outer casing is at most 2 mm, preferably between 0.01 and 1 mm. Normally the gap between the inner casing and the first layer and between the layers in the outer casing will be filled with adhesive. In a preferred embodiment, in which the tubular body is treated by an auto-frettage technique, most empty spaces, preferably all empty spaces, between the inner casing and the layers, will be removed. In the case of one metal strip in a layer, each strip in a layer overlaps another strip in another layer in a longitudinal section for 10 till 90%, preferably for 25 till 75%, more preferably for 40 till 60%. For the longitudinal section especially reference is made to FIG. 2. In the case of two similar strips in a layer, in a similar way as indicated above, an optimum overlap is obtained. In the case of two (or more) dissimilar layers a symmetric arrangement usually results in the best overlap. When different numbers of strips are present in adjacent layers, some strips will overlap for 100%, the other layers preferably overlap in the way as described above. See also FIG. 5.

Suitably, the elongated tubular body comprises an inner casing which is an elongated tubular conduit (or pipe) or a coating or both. The elongated tubular conduit is suitably a metal pipe, especially a steel pipe, more especially a corrosion resistant steel pipe. In principle any material that provides a sealing structure for the contained product that provides resistance to stress or hydrogen induced cracking may be used.

Suitably, the inner casing is a tubular conduit that has been made in a continuous forming process, preferably a roll formed, seam welded metal tube. In another embodiment the inner casing is a welded helical wound metal tube. In the case the inner tubing is made of an organic polymer, the casing may have been made by extrusion. Suitably the inner hollow core has been made from a corrosion resistant material, especially a polymer material, especially derived from C₂-C₄ olefins, including halogenated olefins, acrylonitril, styrene, and/or epoxides, preferably PVC, PE, PU or PP, or a corrosion resistant steel, especially a ferritic stainless steel, a martensitic stainless steel, a duplex stainless steel, an austenitic stainless steel or a chromium/molybdenum/nickel alloy.

The elongated tubular body suitably comprises an inner casing being a metal or polymeric coating, especially an organic polymeric pipe, preferably derived from C₂-C₄, acrylonitril, styrene, and/or epoxides, preferably PVC, PE, PU or PP.

The outer casing of the elongated tubular body is suitably made of steel, stainless steel, titanium or aluminium, preferably a high strength steel as further defined above, especially steels with a high proportion of its material in the martensitic phase. Steel with a high amount of martensitic crystal grains is preferred in view of its high strength. The use of such steels results in tubular structures of relatively high strength and low weight. These steels have tensile strengths between 900 MPa and 1500 MPa. These steels may be obtained from Mittal Steel under the trade name “MartINsite”.

The elongated tubular body as described above is suitably made of a metal strip having a Specified Minimum Yield Stress (SMYS) of at least 100,000 lbs/square inch, preferably between 150,000 and 300,000 lbs/square inch, more preferably between 180,000 and 250,000 lbs/square inch

It is an preferred option to protect the elongated tubular body according as discussed above by one or more protective layers. Thus, the tubular body preferably has a protective casing/coating on the outside of the outer casing. Suitable protective casings are metal casings, for example aluminium casings, steel casings etc. Suitable coatings are polymer coatings, for example PE (polyethylene), PP (polypropylene), PU (polyurethane) and/or PVC (polyvinylchloride) coatings, or bitumen based coatings as well as corrosion protecting paints. Combinations and/or the use of several layers of coatings may also be used. The protective layers may be applied by conventional techniques, for example winding, extrusion, coating etc.

The elongated tubular bodies may be applied with one or more insulating layers, e.g. mineral wool layers, glass fiber layers etc.

The elongated tubular body as discussed above suitably comprises an adhesive layer comprising a strip of adhesive applied to the inner casing and/or between the layers in the outer casing. In principle every adhesive may be used (liquid, powder etc.), but from a practical point of view a strip is preferred. Preferably, the adhesive layer comprises a curable polymer, preferably a film based epoxy having a textile carrier, more preferably Cytec FM 8210-1.

In the elongated tubular body as discussed above, the metal strip suitably has a width of at least 10 mm, more suitably at least 20 mm, preferably between 5 cm and 50 cm, more preferably between 10 and 35 cm, and a thickness of 0.2-5 mm, preferably 0.4-4 mm, more preferably 0.8-2 mm.

The invention also comprises the use of an elongated tubular body as described above in the transport of hydrocarbons as oil and or gas optionally containing hydrogen sulphide and/or carbon dioxide. In addition to oil and gas also water may be present. Further, the tubular bodies can be used for the transport of carbon dioxide, hydrogen, water, steam, ethane, ethene, naphtha etc. A very suitable use is the transport of crude oil and/or natural gas, from off shore platforms to the shore as well as onshore. Another suitable use is the transport of refined oil products, gasoline, gasoil, kerosene, naphtha and LPG.

The use is suitably carried out at temperatures between −20° C. up till 130° C., preferably between −5° C. and 50° C. The pressure in the tubular body is suitably between 1 and 300 bar, more suitably between 10 and 250 bar, especially between 30 and 200 bar.

The elongated tubular body can be made by the application of preformed metal strip together with an adhesive around a tubular inner casing. Preferably a curable adhesive is used. After curing, the tubular body is preferably subject to an auto-frettage operation. Such operations are known in the art. The tubular body is pressurised to a certain pressure above the operating pressure, causing the inner casing to yield but the windings to expand within their elastic limit. Once this pressure is relaxed, the windings are left in a state of residual tension and the inner casing is left in a state of residual compression. Keeping the liner well below its yield stress gives two advantages when the pipe is subsequently cycled in pressure at or below its maximum operating pressure: (a) much lower cyclic tensile stresses on the inner core mean fatigue is greatly reduced; and (b) the liner is relatively low tension or in compression, thus reducing stress corrosion cracking.

The invention will be described hereinafter in more detail and by way of example, with reference to the accompanying drawings, in which:

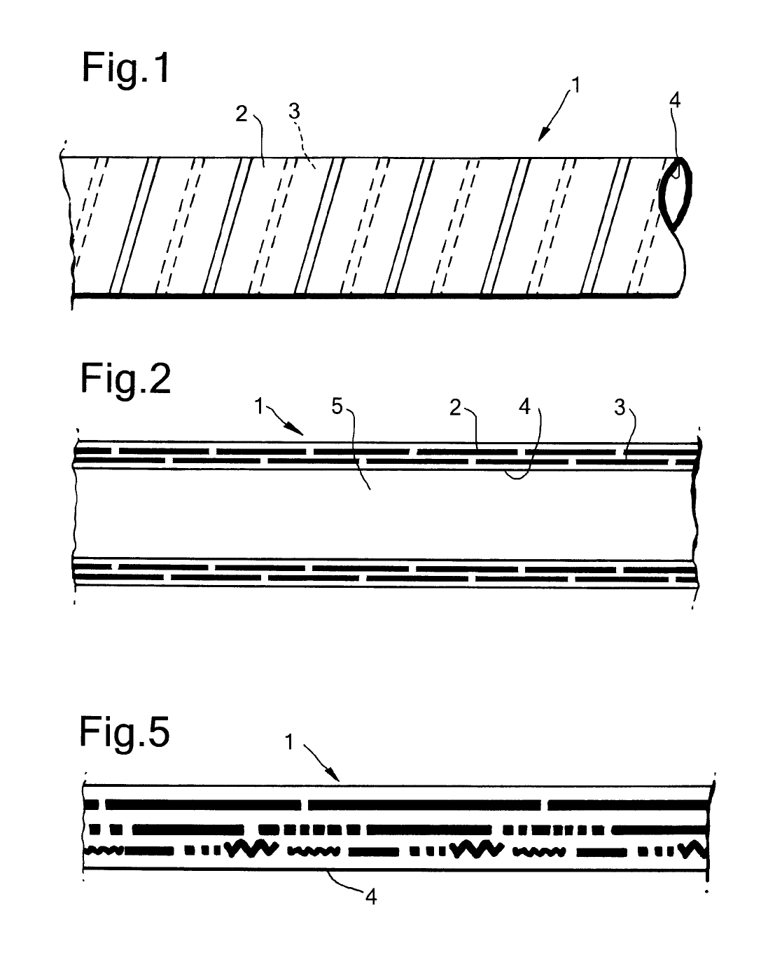

FIG. 1 schematically shows a side view of an embodiment of the tubular body (without outer coating) according to the invention; and

FIG. 2 schematically shows a longitudinal section through the tubular body according to the invention (including an outer coating).

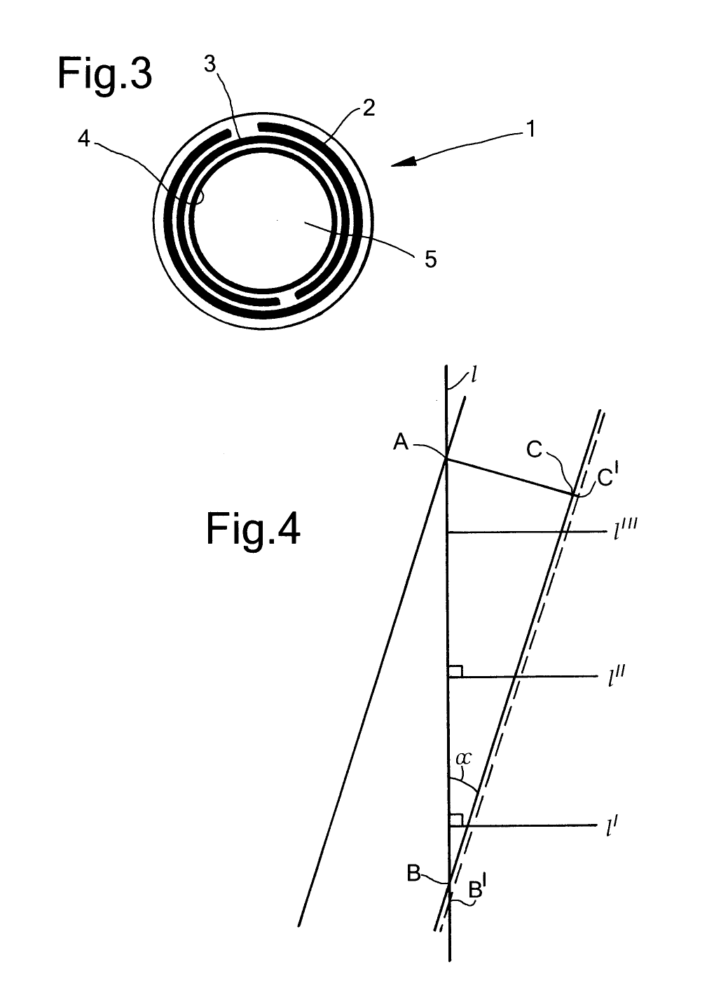

FIG. 3 schematically shows a radial section of the tubular body of FIG. 2.

FIG. 4 shows a part of a flat elongated strip.

FIG. 5 shows a longitudinal section through a tubular body in which the layers comprise different numbers of strips (including an outer coating).

Referring to FIGS. 1, 2 and 3 there is shown a tubular body 1 including two overlapping, elongated metal strips 2 and 3, helically wound around an internal casing 4, the internal casing 4 surrounding the hollow core 5. Each layer consists of one metal strip. The overlap between the strips in the two layers is 50%. Strips 2 and 3 are made of high strength steel. Strip 3 is helically wound around the internal casing 4. Strip 2 is helically wound in a 50% overlapping mode around strip 3. Between the internal casing 4 and strip 3, and between strip 3 and strip 2 there is a thin layer of adhesive. Around the outer metal strip 2 there is a thin layer of a protective coating. FIG. 4 shows the elongated metal strip 3. In the process according to the invention the strip is helically bended around lines perpendicular to line 1, e.g. 1′, 1″ and 1′″. It will be clear that during the bending process the line around which the metal strip is bended, will shift continuously in the direction of bending. The distance C-C′ is the gap between two windings of strip 3. The angle α is the angle lines BA and BC. FIG. 5 shows a part of a three layered tubular body, the first layer comprising 4 strips, the second layer comprises 2 strips and the third layer comprises only one strip. The strip width for each layer (or the pitch of the helix) is the strip width of the outer metal strip. An inner casing 4 is also shown.

Suitable applications for the tubular bodies of the present invention are onshore and offshore pipelines, sub sea risers, well casings and pipe-in-pipe applications.

It will be appreciated that in the case that the tubular body will not comprise an inner casing, the outer casing will directly surround the hollow core.

1. An elongated, multilayered tubular body comprising an elongated, tubular inner hollow core, optionally an elongated, tubular inner casing and an elongated, tubular outer casing, the inner casing surrounding the hollow core, the outer casing surrounding the inner casing, the outer casing comprising at least two layers, each layer consisting of one or more longitudinally preformed, flat elongated metal strips, the preforming of the strips such that the strips have been bent helically in such a way that the consecutive windings of the helix touch or almost touch to each other, each strip in one layer overlapping with other strips in other layers, the layers in the outer casing being bound to each other by an adhesive.

2. An elongated, multilayered tubular body according to claim 1, in which each layer consists of one metal strip.

3. An elongated, multilayered tubular body according to claim 1, in which the elongated tubular body comprises an elongated tubular inner casing.

4. An elongated tubular body according to claim 1, in which the elongated tubular body has a length of at least 10 meters, and in which the inner hollow core has a diameter of between 5 and 250 cm.

5. An elongated tubular body according to claim 1, in which the outer casing comprises between 2 and 16 layers.

6. An elongated tubular body according to claim 1, in which the ratio circumference/strip width being a value between 3 and 40, the circumference being the circumference of the smallest layer of the outer casing.

7. An elongated tubular body according to claim 1, in which each strip in a layer overlaps another strip in another layer from 10 to 90% of a longitudinal section for 10 till 90%.

8. An elongated tubular body according to claim 1, in which the metal strip has a width of at least 2 cm, and has a thickness of 0.2 to 5 mm.

9. An elongated tubular body according to claim 1, in which the inner casing comprises a metal pipe.

10. An elongated tubular body according to claim 1, in which the inner casing comprises a tubular structure that has been made in a continuous forming process.

11. An elongated tubular body according to claim 1, in which the outer casing comprises steel, stainless steel, titanium or aluminium.

12. (canceled)

13. An elongated, multilayered tubular body according to claim 1, in which each layer consists of two metal strips.

14. An elongated tubular body according to claim 1, in which the elongated tubular body has a length of at least 10 meters, between 500 m and 5 km, and in which the inner hollow core has a diameter of between 5 and 250 cm

15. An elongated tubular body according to claim 1, in which the elongated tubular body has a length of at least 10 meters, and in which the inner hollow core has a diameter of between 15 and 125 cm.

16. An elongated tubular body according to claim 1, in which the outer casing comprises between 3 and 8 layers.
